(19) United States
(12) Patent Application Publication
(10) Pub. No.: US 2011/0048210 A1
(43) Pub. Date: Mar. 3, 2011

(54) Cutting apparatus of winder for secondary battery

(76) Inventors: Gi-Bong Cho, Suwon-si (KR); Dae-Sik Oh, Suwon-si (KR); Sung-Jea Park, Suwon-si (KR)

(21) Appl. No.: 12/805,005

(22) Filed: Jul. 7, 2010

(30) Foreign Application Priority Data
Sep. 3, 2009 (KR) 10-2009-0082974

(51) Int. Cl. B26D 7/00

(52) U.S. Cl. 83/659

(57) ABSTRACT

A cutting apparatus of a winder for a secondary battery includes a cutting roll contacting a first side of a material, the cutting roll having a cutter protruding through an outer circumferential surface of the cutting roll to contact the first side of the material during cutting, an anvil roll facing the cutting troll and contacting a second side of the material, the cutting roll and the anvil roll being configured to contact each other via the material only at predetermined process stages, and a controller configured to move the cutting roll and/or the anvil roll to contact each other via the material during the predetermined process stages.

### BACKGROUND

1. Field

Example embodiments relate to a cutting apparatus of a winder for a secondary battery. More particularly, example embodiments relate to a cutting apparatus of a winder for a secondary battery, which can increase the number of products produced per unit time by reducing the production index of the winder for the secondary battery.

2. Description of the Related Art

As the development and demand for mobile technologies have recently increased, demand for secondary batteries, as an energy source, has been rapidly increasing. Accordingly, studies of batteries have been conducted to satisfy various requirements. Particularly, there is a high demand for lithium secondary batteries exhibiting high energy density, high discharge voltage, and high output stability.

Generally, in a secondary battery, an anode and a cathode may be formed by coating active materials on surfaces of a current collector, respectively, and an electrode assembly may be manufactured by interposing a separator between the anode and cathode. Then, the electrode assembly may be inserted into, e.g., a metallic cylinder-shaped or square-shaped container or a pouch-shaped case made of an aluminum laminated sheet. The secondary battery may be manufactured, e.g., by injecting or pouring a liquid electrolyte into the electrode assembly or by using a solid electrolyte.

The electrode assembly may be manufactured to have various sizes in accordance with sizes and shapes of an outer case of the secondary battery and/or in accordance with capacities required in its application fields. Therefore, it may be necessary to perform a process of cutting an electrode into a predetermined size to form a cathode and/or an anode of the electrode assembly.

### SUMMARY

Embodiments are therefore directed to a cutting apparatus of a winder for a secondary battery, which substantially overcomes one or more of the problems due to the limitations and disadvantages of the related art.

It is therefore a feature of an embodiment to provide a cutting apparatus of a winder for a secondary battery, in which an electrode is cut by using a rotary cutter type cutting apparatus while not being stopped but being continuously transferred, so that the production index of the winder for secondary battery can be reduced, thereby increasing the number of products produce per unit time.

At least one of the above and other features and advantages may be realized by providing a cutting apparatus of a winder for a secondary battery, the apparatus including a cutting roll contacting a first side of a material, the cutting roll having a cutter protruding through an outer circumferential surface of the cutting roll to contact the first side of the material during cutting, an anvil roll facing the cutting troll and contacting a second side of the material, the cutting roll and the anvil roll being configured to contact each other via the material only at predetermined process stages, and a controller configured to move the cutting roll and/or the anvil roll to contact each other via the material during the predetermined process stages.

The anvil roll may be movable along a linear direction, and the controller may include a speed controller configured to control a rotating speed of the cutting roll, and a position controller configured to control a space between the cutting and anvil rolls by moving the anvil roll along the linear direction. The speed controller may control the rotating speed of the cutting roll to be changed into a uniform speed or arbitrary speed.

The apparatus may further include a sensor formed prior to the cut position of the material. The sensor may sense the cut position of the material to transmit it to the control system.

A frictional force being in contact with the material may be further formed on at least one of the outer circumferential surface of the cutting roll except the region having the cutter formed therein and the outer circumferential surface of the anvil roll.

The frictional force reinforcing portion may be formed of any one selected from the group consisting of urethane, rubber, acryl and silicon.

The frictional force reinforcing portion may have a surface subjected to concave-convex or embossing treatment so that the sectional area of the surface of the cutting roll is increased.

The anvil roll may be in contact with the cutting roll by the position controller only when the material is cut.

The speed controller may control the rotating speed of the cutting roll to be changed into a uniform speed or arbitrary speed.

The cutting roll may include a contact portion and a non-contact portion, the contact portion being configured to contact the first side of the material during rotation of the cutting roll, and the non-contact portion being configured not to contact the first side of the material during rotation of the cutting roll, and the controller is a speed controller configured to control a rotating speed of the cutting roll. The speed controller may be configured to vary the rotating speed of the cutting roll from a uniform speed to an arbitrary speed. The speed controller may be configured to set the arbitrary speed of the cutting roll to zero. The non-contact portion may be configured to face the first side of the material when the arbitrary speed is zero.

The cutting roll may include a frictional force reinforcing portion on at least one of the contact portion of the cutting roll and an outer circumferential surface of the anvil roll. The anvil roll may be configured to constantly be in contact with the material. A distance between a center of the cutting roll to an outermost circumference of the contact portion is larger than a distance between the center of the cutting roll and an outermost circumference of the non-contact portion.

At least one of the above and other features and advantages may also be realized by providing a cutting apparatus including a cutting roll contacting a first side of a material, the cutting roll having a cutter protruding through an outer circumferential surface of the cutting roll to contact the first side of the material during cutting, and an anvil roll facing the cutting troll and contacting a second side of the material.

A frictional force reinforcing portion being in contact with the material may be further formed on at least one of the outer circumferential surface of the cutting roll except the region having the cutter formed therein and the outer circumferential surface of the anvil roll. A lithium secondary battery may be manufactured using a material cut by the aforementioned apparatus.

### BRIEF DESCRIPTION OF THE DRAWINGS

The above and other features and advantages will become more apparent to those of ordinary skill in the art by describing in detail exemplary embodiments with reference to the attached drawings, in which:

FIG. 1 illustrates a cross-sectional view of a rotary cutter type cutting apparatus according to an embodiment;

FIG. 2 illustrates a cross-sectional view of the moment when an electrode is cut by the cutting apparatus according to an embodiment;

FIG. 3 illustrates an enlarged cross-sectional view of a shape of the cut electrode in FIG. 2;

FIG. 4 illustrates a cross-sectional view of the moment when the electrode is not cut by the cutting apparatus according to an embodiment;

FIG. 5A illustrates a cross-sectional view of the moment when an electrode is cut by a rotary cutter type cutting apparatus according to another embodiment;

FIG. 5B illustrates a cross-sectional view of the moment when the electrode is transferred by the rotary cutter type cutting apparatus according to the other embodiment;

FIG. 5C illustrates a cross-sectional view of the moment when the electrode is not cut by the cutting apparatus according to the embodiment; and

FIG. 6 illustrates a cross-sectional view of a rotary cutter type cutting apparatus according to still another embodiment.

### DETAILED DESCRIPTION

Korean Patent Application No. 10-2009-0082974, filed on Sep. 3, 2009, in the Korean Intellectual Property Office, and entitled: “Cutting Apparatus of Winder for Secondary Battery,” is incorporated by reference herein in its entirety.

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the invention to those skilled in the art.

In the drawing figures, the dimensions of layers and regions may be exaggerated for clarity of illustration. It will also be understood that when an element is referred to as being “on” another element or substrate, it can be directly on the other element or substrate, or intervening elements may also be present. In addition, it will also be understood that when an element is referred to as being “between” two elements, it can be the only element between the two elements, or one or more intervening elements may also be present. Also, when an element is referred to as being “connected to” another element, it can be directly connected to the other element or be indirectly connected to the other element with one or more intervening elements interposed therebetween. Hereinafter, like reference numerals refer to like elements throughout.

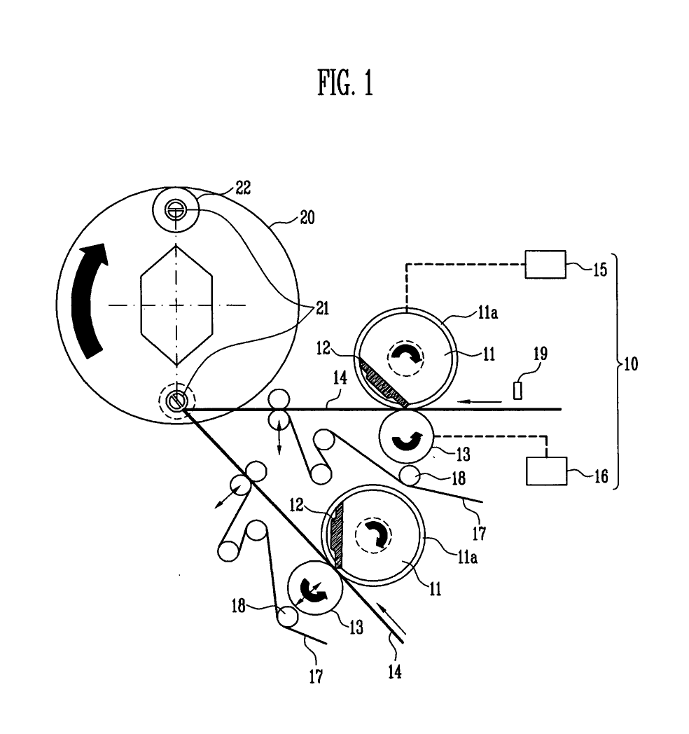

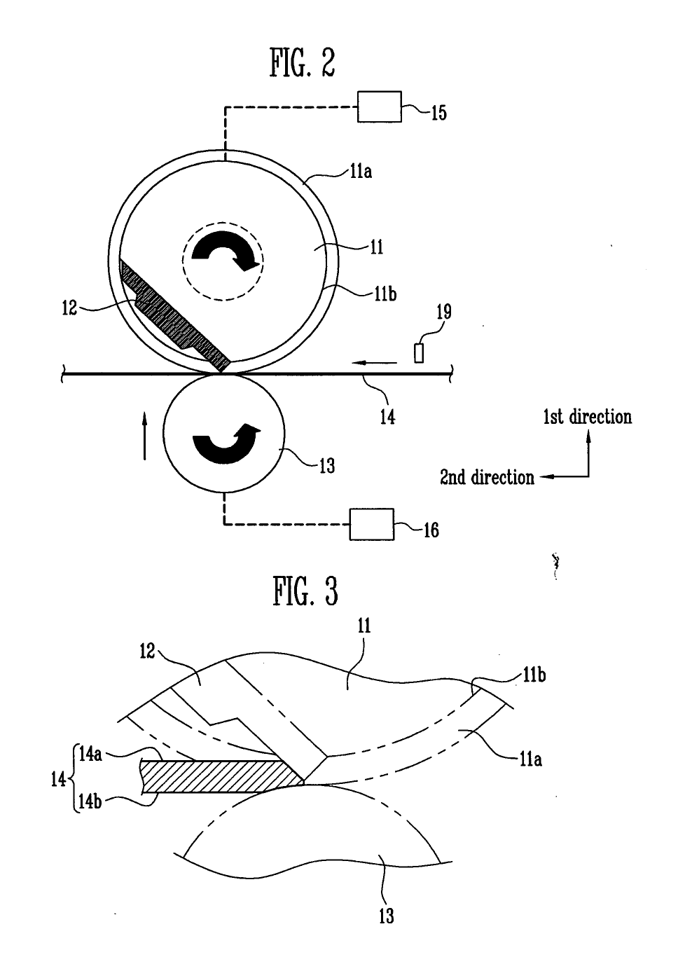

FIG. 1 illustrates a cross-sectional view of a rotary cutter type cutting apparatus according to an embodiment. FIG. 2 illustrates an enlarged cross-sectional view of the rotary cutter of FIG. 1 during cutting according to an embodiment.

Referring to FIG. 1, a winder may include a turret 20, a plurality of guide rolls 18 for supporting a separator 17, and a rotary cutter 10. The rotary cutter 10 may be the rotary cutter type cutting apparatus according to an embodiment.

Referring to FIGS. 1 and 2, the rotary cutter 10 may be used for cutting a material 14 to have a desired length. A cutting roll 11 may be formed at one side of the material 14, and an anvil roll 13 may be formed at the other side of the material 14 to face the cutting roll 11. In other words, the cutting roll 11 and the anvil roll 13 may face each other with the material 14 interposed therebetween. For example, the cutting roll 11 may be formed at a first surface 14a (FIG. 3) of the material 14, and the anvil roll 13 may be formed at a second surface 14b (FIG. 3), i.e., a surface opposite the first surface 14a, of the material 14. For example, the material 14 may be an electrode. Hereinafter, the “material 14” and the “electrode 14” may be used interchangeably.

A cutter 12 may protrude from an outer circumferential surface 11b of the cutting roll 11. The protruding cutter 12 may be formed to be in contact with the electrode 14 during cutting. For example, the cutter 12 may have a linear shape extending from one point on the outer circumferential surface 11b of the cutting roll 11 to protrude through another point on the outer circumferential surface 11b into a frictional force reinforcing portion 11a of the cutting roll 11 to contact the electrode 14.

The frictional force reinforcing portion 11a may be formed on the cutting roll 11, and may be in contact with the electrode 14. The frictional force reinforcing portion 11a may be formed on a portion of the outer circumferential surface 11b of the cutting roll 11. For example, the frictional force reinforcing portion 11a may cover substantially an entire outer circumferential surface 11b of the cutting roll 11, i.e., with the exception of the region where the cutter 12 protrudes the outer circumferential surface 11b. The frictional force reinforcing portion 11a may reinforce the frictional force generated between the electrode 14 and the cutting roll 11. The frictional force reinforcing portion 11a may be formed of one or more of urethane, rubber, acryl, and silicon. The frictional force reinforcing portion 11a may have a surface subjected to concave-convex or embossing treatment so that the sectional area of the surface of the cutting roll 11 may be increased.

The anvil roll 13 may be formed at the other side of the electrode 14 to face the cutting roll 11. The anvil roll 13 may support the cutting roll 11 so that the cutter 12 of the cutting roll 11 may press into the electrode 14 when cutting the electrode 14. For example, the cutting roll 11 and the anvil roll 13 may be arranged along a first direction, e.g., the cutting roll 11 may be on the anvil roll 13 along a vertical direction, so the cutter 12 of the cutting roll 11 may press into the electrode 14 at a tangent point of the cutting roll 11 and the anvil roll 13 when the cutting roll 11 and the anvil roll 13 contact each other.

A control system for controlling operations of the cutting and anvil rolls 11 and 13 may be connected to the rotary cutter 10. The control system may include a speed controller 15 for controlling a rotating speed of the cutting roll 11 and a position controller 16 for controlling a space between the cutting and anvil rolls 11 and 13 by moving the anvil roll 13. In other words, the cutting roll 11 and the anvil roll 13 may be spaced apart from each other, and when the electrode 14 is required to be cut, the position controller 16 may move the anvil roll 13 toward the cutting roll 11 along the first direction to contact each other via the electrode 14.

Since cutting of the electrode 14 is performed only when the anvil roll 13 and the cutting roll 11 contact each other via the electrode 14, control of the distance between the anvil roll 13 and the cutting roll 11 via the position controller 16 may facilitate adjustment of a length of the cut electrode 14, i.e., the length of the cut electrode 14 is not limited to a circumferential length of the cutting roll 11. The speed controller 15 may vary the rotating speed of the cutting roll 11, e.g., to be a uniform speed or any arbitrary speed, so that the length of the electrode 14 may be adjusted according to demand, i.e., an arbitrary length and not limited to the circumferential length of the cutting roll 11 or a multiple of the circumferential length.

As further illustrated in FIGS. 1 and 2, the rotary cutter 10 may include a sensor 19. The sensor 19 may be positioned before a cutting point of the electrode 14, i.e., the sensor 19 may face an uncut electrode 14 and a contact point of the cutting and anvil rolls 11 and 13. In other words, the sensor 19 may be positioned to detect operations of the position and speed controllers 16 and 15, so operations of the position and speed controllers 16 and 15 may be connected to each other, i.e., synchronized. Accordingly, the cut position of the electrode 14 may be transmitted to the control system. The operations of the speed controller 15, the position controller 16, and the sensor 19 will be described in more detail below with reference to FIGS. 2-4.

Referring to FIG. 1, the electrode 14 cut by the rotary cutter 10 may be wound around a winding core 21 together with the separator 17 by the plurality of guide rolls 18. The turret 20 having a plurality of winding cores 21 formed thereon may be used to increase efficiency of the winding operation.

The turret 20 may be a circular disk, and a plurality, e.g., two, of winding cores 21 around which the electrode 14 and the separator 17 are wound together may be formed on the top of the turret 20. Therefore, the turret 20 may be rotated to wind more than one electrode. For example, before winding of one electrode 14 around one winding core 21 is complete, another electrode may be wound around the other winding core 21, thereby saving time. Accordingly, the efficiency of the winding operation can be improved. Reference numeral 22 denotes a wound product.

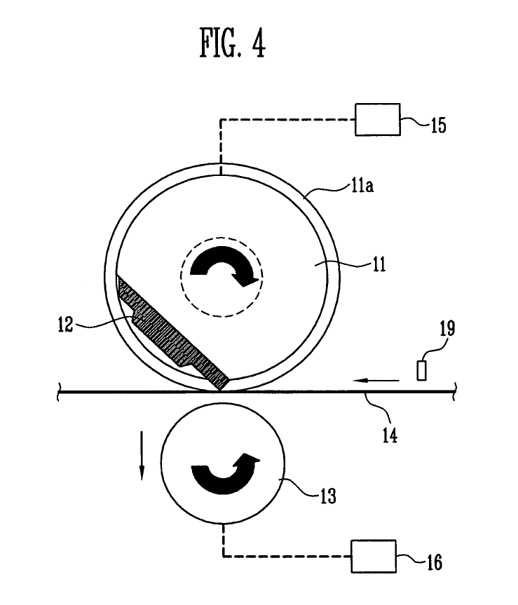

Hereinafter, operation of the rotary cutter type cutting apparatus according to an embodiment will be described. FIG. 2 illustrates a cross-sectional view at the moment when the electrode 14 is cut by the rotary cutter 10, FIG. 3 illustrates a cross-sectional view of a shape of the cut electrode 14, and FIG. 4 illustrates a cross-sectional view at the moment when the electrode 14 is not cut.

Referring to FIGS. 2 to 4, the rotary cutter 10 may include the cutting roll 11 having the cutter 12 protruding from the outer circumferential surface 11b thereof, so that the cutter 12 may be in contact with the electrode 14 at one side of the electrode 14 through its rotation. The anvil roll 13 may be formed at the other side of the electrode 14 to face the cutting roll 11 with the electrode 14 interposed therebetween. The speed controller 15 and the position controller 16 may control the rotating speed of the cutting roll 11 and the position of the anvil roll 13, respectively. The cut position of the electrode 14 may be transmitted by the sensor 19 to the control system, so the operations of the position and speed controllers 16 and 15 may be connected to each other.

As illustrated in FIG. 4, while being wound on the turret 20, the electrode 14 may be in contact with the cutting roll 11, and the anvil roll 13 may be spaced apart from the electrode 14. In other words, when the electrode 14 is not cut, the position controller 16 may control the anvil roll 13 to be spaced apart from the cutting roll 11, e.g., the position controller 16 may arbitrarily control the position of the anvil roll 13 with respect to the cutting roll 11. Therefore, the winding operation may continue without cutting the electrode 14.

When the wound electrode 14 reaches a desired length and the cut position of the electrode 14 is sensed by the sensor 19, the sensor 19 may transmit the cut position to the position and speed controllers 16 and 15 in the control system. Next, as illustrated in FIG. 2, the position controller 16 may move the anvil roll 13 along the first direction to contact the cutting roll 11 via the electrode 14 in order to cut the electrode 14. The speed controller 16 may be operated in connection with the position controller 15, e.g., the speed controller 16 may control the rotating speed of the cutting roll 11 not to be a uniform speed but to be an arbitrary speed before the anvil roll 13 is in contact with the cutting roll 11. Accordingly, when the anvil roll 13 contacts the cutting roll 11 via the electrode 14 at the cut position, the cutter 12 of the cutting roll 11 may be positioned to contact and push into the electrode 14 at the transmitted cut position of the electrode 14. For example, the cutter 12 may cut the electrode 14, e.g., only, when the electrode 14 is pressed simultaneously from opposite sides by the anvil roll 13 and the cutting roll 11.

That is, the operation of the anvil roll 13 may be controlled by the position controller 16, so that the cutting and anvil rolls 11 and 13 may be in contact with each other via the electrode 14 only when the electrode 14 is at the cut position. The cutting and anvil rolls 11 and 13 may be spaced apart from each other when the electrode 14 is not cut. Accordingly, the length of the electrode 14 cut by the cutter 12 may not be limited to the length of the circumferential length of the cutting roll 11. While the cutting and anvil rolls 11 and 13 are spaced apart from each other, the speed controller 15 may control the rotating speed of the cutting roll 11 not to be changed into a uniform speed but to be changed into an arbitrary speed. Accordingly, the electrode 14 may be cut not to have a multiple of the circumferential length of the cutting roll 11 but to have an arbitrary length.

As illustrated in FIG. 3, since the anvil roll 13 and the cutting roll 11 contact the electrode 14 simultaneously from opposite surfaces during cutting, the side section of the cut electrode 14 may have a shape in which both corners of the cut end of the cut electrode 14 are pressed. In other words, both first and second surfaces 14a and 14b of the cut electrode 14 may have inclined surface portions. For example, the inclined surface portion of the first surface 14a, i.e., a surface close to the cutting roll 11, may be more inclined than the inclined surface portion of the second surface 14b, i.e., a surface close to the anvil roll 13.

Once the electrode 14 is cut, the cut electrode 14 may continue moving along the second direction, e.g., may be transferred an arbitrary distance in a direction from the cutting roll 11 toward the turret 20, by a friction force between the frictional force reinforcing portion 11a of the cutting roll 11 and the electrode 14. The frictional force reinforcing portion 11a may be formed of a resin, e.g., urethane, a viscoelastic material, e.g., rubber, or a material processed for enhancing a frictional force on the surface of the cutting roll 11. That is, the frictional force reinforcing portion 11a may increase the frictional force generated between the electrode 14 and the cutting roll 11, so that the front end of the electrode 14, after cutting the electrode 14 at the state that the anvil and cutting rolls 13 and 11 are closely in contact with each other, may be transferred to a position at which a next electrode may be wound on the turret 20. For example, the cutting roll 11 may rotate continuously, so after cutting one electrode 14, a next electrode may be wound on the turret continuously without stopping the winding and/or cutting processes.

In other words, by using the rotary cutter 10 according to an embodiment, the electrode 14 may be cut without instantaneous stops, i.e., while being continuously moved. Accordingly, the production index of the winder for the secondary battery may be reduced, and therefore, a number of products produced per unit time may be increased, thereby improving productivity. In contrast, a conventional cutter, e.g., a shear type cutter, may require deceleration of an electrode to a stop in order to facilitate cutting of the electrode by blades, followed by gradual acceleration of the electrode to be advanced toward a winding core to form a jelly roll of wound electrode and separator. As such, winding of the conventionally-cut electrode is not continuous, thereby resulting in direct production loss caused by time loss. Further, when the conventionally-cut electrode is accelerated/decelerated, an abrupt change in tension applied to the electrode may result in a thickness change in the electrode, thereby lowering quality of the products. Another conventional cutter, e.g., a laser, may require expensive equipment and a slow cutting speed, thereby resulting in economic disadvantages.

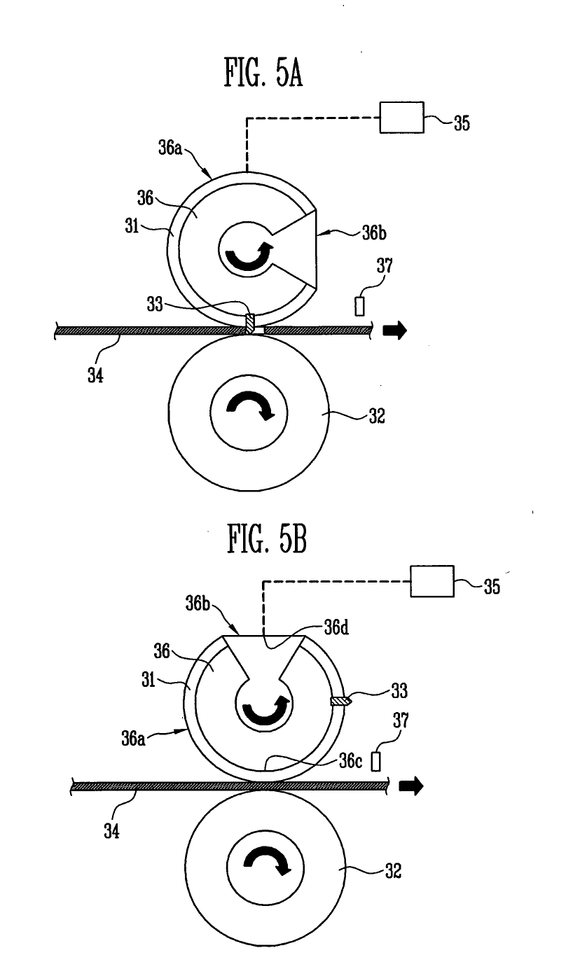

Hereinafter another embodiment will be described with reference to FIGS. 5A-5C. FIG. 5A illustrates a cross-sectional view of a rotary cutter at the moment when an electrode is cut. FIG. 5B illustrates a cross-sectional view of the rotary cutter at the moment when the electrode is transferred. FIG. 5C illustrates a cross-sectional view of a rotary cutter at the moment when the electrode is not cut.

Referring to FIGS. 5A to 5C, a rotary cutter type cutting apparatus according to an embodiment may include a cutting roll 36 formed at one side of an electrode 34, an anvil roll 32 formed at the other side of the electrode 34 to face the cutting roll 36, a speed controller 35 for controlling the rotating speed of the cutting roll 36, and a sensor 37.

The cutting roll 36 may include a contact portion 36a in contact with the electrode 34, a cutter 33 protruding from an outer circumferential surface of the contact portion 36a, and a non-contact portion 36b not in contact with the electrode 34 even when the cutting roll 36 is rotated. The sensor 37 may be formed prior to the cut position of the electrode 34, so if a cut position of the electrode 34 is sensed, the sensor 37 may transmit the cut position of the electrode 34 to the speed controller 35.

The contact portion 36a of the cutting roll 36 may include a frictional force reinforcing portion 31 along a portion of an outer circumferential surface of the cutting roll 36 to define a first circumferential portion 36c. The non-contact portion 36b may define a second circumferential portion 36d. The first and second circumferential portions 36c and 36d may be different from each other, and may not overlap each other. A distance between the second circumferential portion 36d to a center of the cutting roll 36 may be smaller than a radius of the cutting roll 36, i.e., a distance from the center of the cutting roll 36 to first circumferential portion 36c. Therefore, when the cutting roll 36 is adjusted to have the first circumferential portion 36c contact the electrode 34, i.e., a distance between the electrode 34 and the center of the cutting roll 36 may equal the radius of the cutting roll 36, the second circumferential portion 36d may not contact the electrode 34 during rotation of the cutting roll 36. In this embodiment, the non-contact portion 36b may be formed so that a side section of the cutting roll 36, i.e., the second circumferential portion 36d, has a straight line shape. However, the side section of the cutting roll 36 may have any suitable shape, as long as the non-contact portion 36b of the cutting roll 36 is not in contact with the electrode 34 when the cutting roll 36 is rotated.

Referring to FIG. 5A, when the sensor 37 senses the cut position of the electrode 34, during winding of the electrode 34 via rolls (not shown) for supporting the electrode 34, the sensor 37 may transmit the cut position of the electrode 34 to the speed controller 35. Accordingly, the speed controller 35 may control the rotating speed of the cutting roll 36 to be a uniform speed or an arbitrary speed. Then, the cutting roll 36 may be rotated, so that the cutter 33 may be positioned at the cut position to cut the electrode 34. The cutter 33 may be any suitable cutter, e.g., a linear cutter extending from the cutting roller 36 through the frictional force reinforcing portion 31 to contact the electrode 34, as long as the cutter 34 is configured to protrude from the outer circumferential surface of the contact portion 36a to contact the electrode 34.

Subsequently, referring to FIG. 5B, the frictional force reinforcing portion 31 formed on the outer circumferential surface of the cutting roll 36 may allow the electrode 34 to be transferred to the position at which the front end of the cut electrode 34 may be wound in the state that the cutting roll 36 is in contact with the anvil roll 32. In other words, a contact between the cutting roll 36 and the anvil roll 32 via the electrode 34 may generate a frictional force to continue movement of the electrode 34 after cutting. Operation and composition of the frictional force reinforcing portion 31 may be substantially the same as those of the frictional force reinforcing portion 11a.

Subsequently, referring to FIG. 5C, if the electrode 34 is transferred to the position at which the cut electrode 34 can be wound, the rotating speed of the cutting roll 36 may be controlled by the speed controller 35 so that the non-contact portion 36b of the cutting roll 36 may be positioned on the electrode 34. That is, when the electrode 34 is not cut, the rotating speed of the cutting roll 36 may be controlled so the cutter 33 of the cutting roll 36 may not, e.g., directly, contact the electrode 34, and the non-contact portion 36b may face the electrode 34 with a space therebetween, e.g., the speed controller 35 may adjust the rotating speed of the cutting roll 36 to zero. Accordingly, the length of the electrode 34 may be set not to be limited to the circumferential length of the cutting roll 36.

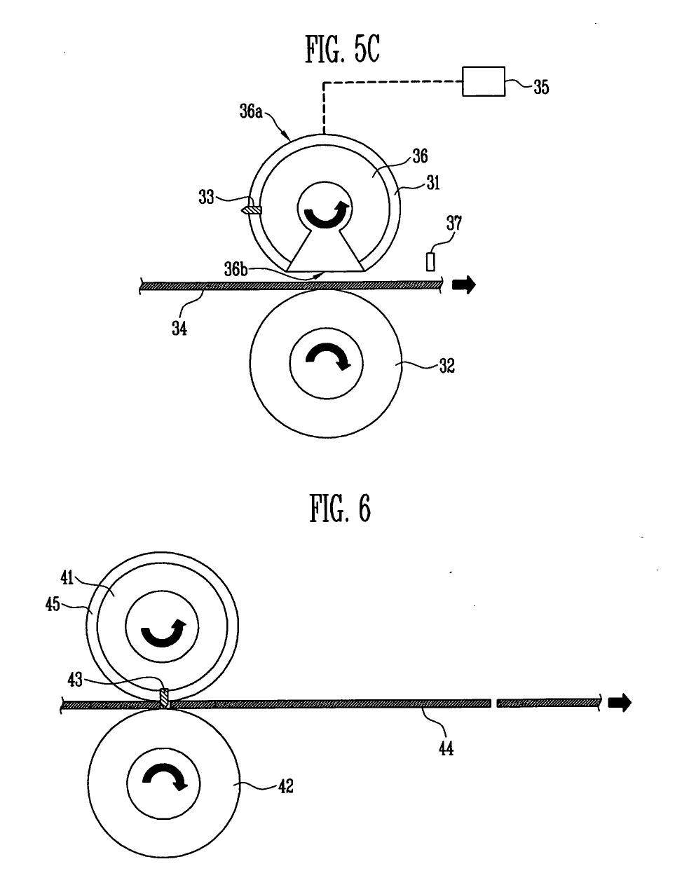

FIG. 6 illustrates a cross-sectional view of a rotary cutter type cutting apparatus according to another embodiment. It is noted that the rotary cutter in FIG. 6 may be an apparatus used in producing only single products.

Referring to FIG. 6, a cutting roll 41 may be formed to be in contact with an electrode 44 at one side of the electrode 44. The cutting roll 41 may include a cutter 43 protruding from an outer circumferential surface thereof. An anvil roll 42 may be formed to be in contact with the electrode 44 at the other side of the electrode 44. The cutting and anvil rolls 41 and 42 may face each other with the electrode 44 interposed therebetween. The outer circumferential surface of the cutting roll 41 may be formed as a frictional force reinforcing portion 45. The frictional force reinforcing portion 45 may cover substantially the entire outer circumferential surface of the cutting roll 41, i.e., with the exception of a region of the cutter 43. Operation and composition of the frictional force reinforcing portion 45 may be substantially the same as those of the frictional force reinforcing portion 11a.

In the case of the single products electrodes required in the single products may have the same length. Therefore, the length of the electrode 44 may be set to correspond to the circumferential length of the cutting roll 41, thereby continuously cutting the electrode 44 as the cutting roll 41 rotates.

As described above, according to various embodiments, an electrode may be cut by rotary cutter type cutting apparatus while not being instantaneously stopped but being continuously moved. Accordingly, the production index of the winder for a secondary battery may be reduced, and therefore, a number of products produced per unit time may be increased, thereby improving productivity. Further, production lines may be configured by reducing equipment as productivity is improved, thereby saving equipment investment cost and reducing a processing area necessary for equipments. For example, the electrode produced according to embodiments may be applied to lithium secondary batteries.

In embodiments, a frictional force reinforcing portion may be formed only on an outer circumferential surface of a cutting roll. It is noted, however, that other configurations of the frictional force reinforcing portion, e.g., the frictional force reinforcing portion may be formed only on an outer circumferential surface of an anvil roll or on outer circumferential surfaces of both the cutting and anvil rolls.

Exemplary embodiments have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A cutting apparatus of a winder for a secondary battery, the apparatus comprising:
a cutting roll contacting a first side of an electrode material, the cutting roll having a cutter protruding through an outer circumferential surface of the cutting roll to contact the first side of the electrode material during cutting;
an anvil roll facing the cutting troll and contacting a second side of the electrode material, the cutting roll and the anvil roll being configured to contact each other via the electrode material only at predetermined process stages; and
a controller configured to move the cutting roll and/or the anvil roll to contact each other via the electrode material during the predetermined process stages.

2. The apparatus as claimed in claim 1, wherein:
the anvil roll is movable along a linear direction; and
the controller includes a speed controller configured to control a rotating speed of the cutting roll, and a position controller configured to control a space between the cutting and anvil rolls by moving the anvil roll along the linear direction.

3. The apparatus as claimed in claim 2, wherein the anvil roll is configured to contact the electrode material only during cutting.

4. The apparatus as claimed in claim 2, wherein the speed controller is configured to vary the rotating speed of the cutting roll from a uniform rotating speed to an arbitrary speed.

5. The apparatus as claimed in claim 1, further comprising a sensor positioned before a cut position of the electrode material, the sensor being configured to sense the cut position of the electrode material and transmit the cut position to the controller.

6. The apparatus as claimed in claim 1, wherein the cutting roll includes a frictional force reinforcing portion on the outer circumferential surface of the cutting roll, the frictional force reinforcing portion being in contact with the electrode material.

7. The apparatus as claimed in claim 6, wherein the cutter of the cutting roll protrudes through the frictional force reinforcing portion.

8. The apparatus as claimed in claim 6, wherein the frictional force reinforcing portion includes one or more of urethane, rubber, acryl and silicon.

9. The apparatus as claimed in claim 6, wherein the frictional force reinforcing portion includes concave-convex portions or embossing.

10. The apparatus as claimed in claim 1, wherein:
the cutting roll includes a contact portion and a non-contact portion defining the outer circumferential surface of the cutting roll, the contact portion being configured to contact the first side of the electrode material during rotation of the cutting roll, and the non-contact portion being configured not to contact the first side of the material during rotation of the cutting roll; and
the controller is a speed controller configured to control a rotating speed of the cutting roll.

11. The apparatus as claimed in claim 10, wherein the speed controller is configured to vary the rotating speed of the cutting roll from a uniform speed to an arbitrary speed.

12. The apparatus as claimed in claim 11, wherein the speed controller is configured to set the arbitrary speed of the cutting roll to zero.

13. The apparatus as claimed in claim 11, wherein the non-contact portion is configured to face the first side of the material when the arbitrary speed is zero.

14. The apparatus as claimed in claim 10, wherein the cutting roll includes a frictional force reinforcing portion on at least one of the contact portion of the cutting roll and an outer circumferential surface of the anvil roll.

15. The apparatus as claimed in claim 10, wherein the anvil roll is configured to constantly be in contact with the electrode material.

16. The apparatus as claimed in claim 10, wherein a distance between a center of the cutting roll to an outermost circumference of the contact portion is larger than a distance between the center of the cutting roll and an outermost circumference of the non-contact portion.

17. A cutting apparatus of a winder for a secondary battery, the apparatus comprising:
a cutting roll contacting a first side of an electrode material, the cutting roll having a cutter protruding through an outer circumferential surface of the cutting roll to contact the first side of the electrode material during cutting; and
an anvil roll facing the cutting troll and contacting a second side of the material.

18. The apparatus as claimed in claim 17, wherein:
the cutting roll includes a frictional force reinforcing portion on at least one of an outer circumferential surface of the cutting roll and an outer circumferential surface of the anvil roll; and
the cutting roll and anvil roll are in constant contact with each other.
